(19) United States
(12) Patent Application Publication
(10) Pub. No.: US 2011/0235176 A1
(43) Pub. Date: Sep. 29, 2011

(54) POLARIZING GLASS HAVING HIGH EXTINCTION RATIO

(75) Inventors: Takurou Ikeda, Hyogo (JP); Kozo Maeda, Hyogo (JP); Toru Yano, Hyogo (JP); Hitomi Matsumoto, Hyogo (JP)

(73) Assignee: NIHON YAMAMURA GLASS CO., LTD., Hyogo (JP)

(21) Appl. No.: 13/128,970

(22) PCT Filed: Jun. 24, 2009
(86) PCT No.: PCT/JP2009/061532

§ 371 Date: May 12, 2011

(30) Foreign Application Priority Data
Nov. 27, 2008 (JP) 2008-303229
Jun. 5, 2009 (JP) 2009-136209

(51) Int. Cl. G02B 5/30; C03B 32/00; C03B 23/00

(52) U.S. Cl. 359/487.06; 65/32.5

(57) ABSTRACT

There are disclosed an improved method for production of a polarizing glass having a high extinction ratio by facilitating control of the diameter of silver halide particles in a mother glass with high Ag concentration, and a polarizing glass produced by the method. The glass is a polarizing glass having dispersed and oriented geometrically anisotropic metallic silver particles at least in its surface layer, which is characterized by not containing TiO₂ exceeding 1.7 wt % but containing not less than 0.4 wt % Ag, and in that Ag and halogens contained therein satisfy the following relations: the molar ratio of Ag/(Cl+Br) is 0.2 to 1.0; the molar ratio of Cl/(Cl+Br+F) 0.5 to 0.95; and the molar ratio of Br/(Cl+Br+F) 0.05 to 0.4. The method for production comprises the steps of drawing a glass containing dispersed AgClₓBr₁₋ₓ crystals, and then reducing it under a reducing atmosphere.

### TECHNICAL FIELD

The present invention relates to a method for production of a polarizing glass used in optical isolators, LCD projectors and the like, in particular to a method applicable to production of a polarizing glass for light in the visible and the infrared regions, as well as a polarizing glass produced by the method.

### BACKGROUND ART

Basic methods for production of a polarizing glass containing dispersed, geometrically anisotropic metallic silver particles are disclosed in Patent Documents 1-3. According to these methods, a glass containing Ag and halogen (Cl, Br or I) in its composition is heat treated to let silver halide particles precipitate, and after extruded or drawn to give a glass containing dispersed, geometrically anisotropic silver halide particles, the glass thus obtained is subjected to a reduction treatment to give a polarizing glass which contains dispersed, geometrically anisotropic metallic silver particles.

A glass of this type sometimes exhibits a photochromic property, which is not needed for achieving high transmittance. Patent Document 2 above discloses not only photochromic compositions including CuO, but also non-photochromic compositions which are substantially CuO-free or in which the molar ratio of (R₂O—Al₂O₃):B₂O₃ is lower than 0.25 (wherein R₂O denotes an alkali metal oxide). In a glass of such types, however, precipitation of metallic silver particles sometimes occurs at a heat treatment step which is intended to let silver halide particles precipitate. CuO has been added to prevent this, i.e., as an ingredient which functions as an oxidizer to prevent reduction of silver halide into metallic silver at the heat treatment step.

Patent Document 4 discloses compositions for non-photochromic glass which include CeO₂ instead of CuO. CeO₂ is selected there as a material which, while functioning as an oxidizer, does not give rise to a photochromic property. It is described, however, that CeO₂, instead, sometimes acts as a nucleus forming agent and thereby induces devitrification of the glass. Further, CuO and CeO₂ are added as oxidizers, and they thus may hinder reduction of Ag in the process of reduction treatment with hydrogen.

Further, Patent Document 5 discloses another non-photochromic glass of a composition including neither CuO nor CeO₂. This glass is made non-photochromic by lowering Al₂O₃ content while increasing K₂O content, thereby making the glass more basic.

Patent Document 6 discloses compositions containing less than 1 wt % TiO₂, which is useful in melting multiple different glasses in a single glass melting apparatus.

Absorption properties of a polarizing glass, where the aspect ratio (ratio of major axis:minor axis) of metallic silver particles contained therein is constant, are determined by the amount of metallic silver which is contained per unit area of the polarizing glass (i.e., concentration of metallic silver particles×thickness of reduced layer). Extinction ratio therefore becomes higher as amount of metallic silver per unit area is increased.

Therefore, in order to obtain a polarizing glass having a high extinction ratio [which is expressed as maximum transmitted light power/minimum transmitted light power, without unit or in decibel (dB)], one may use such means as raising the concentration of metallic silver particles and/or increasing the thickness of reduced layer. Patent Document 7 discloses that reduction is conducted so as to make the thickness of reduced layer to be at least 10 μm, preferably 50 μm or more.

Among them, for increasing the thickness of the reduced layer, there are methods by raising reduction temperature and extending reduction time (not less than 12 hours), and by intensifying reduction treatment through application of high hydrogen partial pressures (10 atm or more) as described in Patent Documents 7 to 10.

In Patent Documents 7 to 10, since raising reduction temperature and/or extending reduction time could bring about respheroidization of drawn silver halide particles, pressurized reduction is used for intensifying reduction treatment. In this method, however, once the pressure is elevated higher than the pressure under which glass surface is saturated with hydrogen, no further pressurizing could intensify the reduction treatment any more. In addition, as this reduction treatment is a process which is rate-determined by diffusion in solid, there is a limit for increasing the thickness of the reduced layer within a practical period of time. Further, this method has a problem in safety, for it uses high pressure hydrogen at a high temperature in a pressurizing reduction apparatus.

Therefore, the other of the methods is needed for increasing the total amount of precipitated metallic silver particles, i.e., the method of raising the concentration of metallic silver particles, in order to obtain a polarizing glass having a high extinction ratio simply and easily.

In the compositions of the glasses employed in Patent Documents 1 to 10, their Ag content is not more than 4 wt %. Therefore, the total amount of precipitating metallic silver particles is fairly limited there. Therefore, in order to achieve a high extinction ratio with such glasses, it is unavoidable to conduct reduction treatment for a very long time and/or under a pressurized atmosphere.

Patent Document 5, as its example, discloses compositions having a relatively high Ag content, too: for example, a composition containing 0.4 wt % Ag, which is presented in Table 1 as Comparative Example 6 in the section of Examples of the present specification. This composition, however, induces devitrification of the mother glass during its molding, and thereby making it difficult to control the particle size of silver halide particles.

The absorption cross section, CABS, of a polarizing glass in which metallic silver particles of a given aspect ratio are dispersed can be calculated based on Non-Patent Document 1, using equations (1) to (5). In these equations, V is the volume of the metallic silver particle, N₀ is the refractive index of the glass (=1.5), λ is the wavelength (μm) of light, L is the depolarization factor, ε₁ and ε₂ are the real part and the imaginary part of the electric permittivity of silver.

$$\begin{matrix}[ Math 1 ] & \\ {C}_{ABS} = \frac{2 π V {N}_{0}^{3}}{{L}^{2} λ} \frac{{ɛ}_{2}}{{[ {ɛ}_{1} + {N}_{0}^{2} ( 1 / L - 1 ) ]}^{2} + {ɛ}_{2}^{2}} & ( 1 )\end{matrix}$$

wherein,

[Math 2]

ε₁=5−55λ² (2)

[Math 3]

ε₂=0.06+27λ exp(−29λ²)+1.6λ³ (3)

$$\begin{matrix}[ Math 4 ] & \\ L = \frac{1 - {e}^{2}}{{e}^{2}} [ - 1 + \frac{1}{2 e} ln ( \frac{1 + e}{1 - e} ) ] & ( 4 )\end{matrix}$$

When “a” stands for the length of the major axis, and “b” for the length of the minor axis, of a metallic silver particle which is a spindle-shaped spheroid (i.e., aspect ratio is a/b), “e” in the above equation (4) is calculated by the following equation (5).

$$\begin{matrix}[ Math 5 ] & \\ e = \sqrt{1 - {( \frac{b}{a} )}^{2}} & ( 5 )\end{matrix}$$

Further, maximum absorption wavelength λmax (μm) is calculated by the following equation (6), using the above equations (4) and (5).

$$\begin{matrix}[ Math 6 ] & \\ {λ}_{max} ≅ \sqrt{\frac{5 + {N}_{0}^{2} ( 1 / L - 1 )}{55}} & ( 6 )\end{matrix}$$

FIG. 1 illustrates the relation between the aspect ratio and the maximum absorption wavelength λmax which is derived from the above equations (4) to (6). (Wavelength is shown in nm.) For example, it is when the aspect ratio is 1.4:1 that λₘₐₓ takes the value of 460 nm.

For example, in a spindle-shaped spheroid whose aspect ratio is 2:1 or 11:1, the depolarization factor L in the direction of the major axis is 0.174 or 0.018, respectively. FIG. 2 shows the calculation results of the absorption cross section for the two types of metallic silver particles of these shapes.

As derived from these equations, the absorption cross section becomes smaller when a polarizer is for a shorter wavelength, if the total amount of metallic silver particles is constant. Therefore, if the other conditions are the same, an increased amount of metallic silver particles must be precipitated in order to produce a polarizer for the visible region in comparison with a polarizer for the infrared region having the same absorption cross section.

For precipitating metallic silver particles at high concentrations, it is needed to increase the concentration of the Ag component in the polarizing glass composition. But, there have been following problems in such glasses that are characterized only in having an increased concentration of the Ag component in comparison with conventional glass compositions as described in prior art examples.

Namely, it is the problem that devitrification occurs during the cooling process for formation of the mother glass before drawing, i.e., the problem that silver halide particles precipitate, thereby making the glass opaque.

In the process for producing a polarizing glass of this type, the mother glass prepared is heat treated to let silver halide particles precipitate. Since not only transmission loss of the glass but also the optimal condition for conducting a drawing process vary depending on the particle size of the silver halide particles which have been precipitated, it is important to control the particle size of the silver halide particles. Generally, it is sufficient to let silver halide particles precipitate with their mean diameter falling in the range of about 20 to 500 nm by regulating the temperature and the length of time of the heat treatment. However, whereas, as an advantage, the greater the mean diameter of silver halide particles is, the more easily are the particles drawn during the drawing of the mother glass, thus making it easier to obtain high aspect ratio particles, too great a mean diameter would apt to lower the transparency of the glass, particularly for shorter wavelength light. Therefore, it is preferable to provide the particles with an appropriate mean particle diameter (or to select and employ a glass in which the silver halide particles have an appropriate mean diameter) in accordance with the extinction ratio and the insertion loss to be achieved for the wavelength of targeted light. As a rough standard for this purpose, it is sufficient, for example, to cause the mean diameter of the silver halide particles to fall in the range of 20 to 100 nm in order to obtain a polarizing glass having its maximum absorption in the visible region of not less than 500 nm but below 650 nm (i.e., having its maximum extinction ratio in this wavelength region); or to cause the mean diameter of the silver halide particles to fall in the range of 40 to 150 nm in order to obtain a polarizing glass having its maximum absorption in the wavelength region of not less than 650 nm but below 1300 nm; or to cause the mean diameter of the silver halide particles to fall in the range of 60 to 200 nm in order to obtain a polarizing glass having its maximum absorption in the wavelength region of not less than 1300 nm but below 1600 nm.

Further, devitrification of the mother glass would bring about a state that the particle diameter of the silver halide particles varies between the edge part and the middle part of the mother glass, causing, as a result, uneven product properties and, therefore, lowered productivity.

In addition, that silver halide particles are precipitated by a heat treatment process means that the solubility of silver halide is low in the mother glass. Therefore, if the concentration of Ag is simply increased in those conventional mother glass compositions, mother glasses of such compositions will become thermally unstable, and, therefore, devitrification will likely occur during the cooling process for mother glass formation. Therefore, if the Ag component concentration is simply increased hoping to obtain a polarizing glass having a high extinction ratio, it will broaden the temperature range where devitrification of the mother glass occurs and will make it difficult to control the particle size of silver halide crystals, thus adversely affecting the product properties.

On the other hand, a phenomenon (mixed mobile ion effect) is known in which, depending on how different ions are combined in a glass, remarkable deviation of various properties of a glass is observed, from what is expected based on the sum of the effect of each ion (additivity). (See Non-Patent Document 2)

### PRIOR ART REFERENCES

### Patent Document

Patent Document 1: U.S. Pat. No. 4,282,022
Patent Document 2: U.S. Pat. No. 4,479,819
Patent Document 3: U.S. Pat. No. 4,486,213
Patent Document 4: U.S. Pat. No. 5,252,524
Patent Document 5: Japanese Patent Application Publication No. 2003-98349
Patent Document 6: Japanese Patent Application Publication No. 2005-504711
Patent Document 7: U.S. Pat. No. 4,908,054
Patent Document 8: U.S. Pat. No. 6,221,480
Patent Document 9: U.S. Pat. No. 6,761,045
Patent Document 10: U.S. Pat. No. 6,887,808

### Non-Patent Document

Non-Patent Document 1: T. P. Seward III, J. Non-Cryst. Solids, Vol. 40, pp 499-513 (1980).
Non-Patent Document 2: Garasu Kogaku Handbook, Asakura Shoten, 1999, pp 146-147

### DESCRIPTION OF INVENTION

### The Problem to be Solved

Against the above backgrounds, the object of the present invention is to provide an improved method for production of a polarizing glass having a high extinction ratio, which method facilitates to control the particle size of the silver halide particles by confining the temperature range into a narrow width where devitrification would occur in the mother glass having a high Ag concentration, as well as a polarizing glass produced by the method.

### The Means to Solve the Problem

The present inventors produced a variety of glasses with different compositions and examined the diffusion rate of halogens and the solubility of halogens and silver in them, and thereby have found a ratio of halogen elements which can inhibit devitrification even in a mother glass having a high concentration of the Ag component, by regulating the temperature range where precipitation of silver halide particles takes place. Namely, they found that the above objectives can be achieved when mutual ratios among Ag and halogen contents in a glass composition fall into given ranges, and then, through further studies, have completed the present invention. More specifically, the present invention provides the following.

(1) A method for production of a polarizing glass comprising geometrically anisotropic metallic silver particles dispersed and oriented at least in a surface layer thereof, which method comprises the steps of drawing a glass containing dispersed AgClₓBr₁₋ₓ (0≦x≦1) crystals, and then reducing the glass under a reduction atmosphere,

wherein the polarizing glass does not contain TiO₂ exceeding 1.7 wt %, but contains not less than 0.4 wt % Ag, and

wherein Ag and halogens contained in the polarizing glass satisfy the following relations:

the molar ratio of Ag/(Cl+Br) is 0.2 to 1.0,

the molar ratio of Cl/(Cl+Br+F) is 0.5 to 0.95, and

the molar ratio of Br/(Cl+Br+F) is 0.05 to 0.4.

(2) The method for production of the above (1), wherein the halogens contained in the polarizing glass satisfy a relation that the molar ratio of F/(Cl+Br+F) is 0.01 to 0.4.

(3) The method for production of the above (1) or (2), wherein the composition of the polarizing glass comprises

SiO₂: 40 to 63 wt %

B₂O₃: 15 to 26 wt %

Al₂O₃: 5 to 15 wt %

ZrO₂: 7 to 12 wt %

R¹₂O: 4 to 16 wt %

(wherein, R¹ inclusively represents Li, NaK and Cs, provided that these satisfy the following: Li₂O: 0 to 5 wt %, Na₂O: 0 to 9 wt %, K₂O: 0 to 12 wt %, Cs₂O: 0 to 6 wt %)

R²O: 0 to 7 wt %

(wherein, R² inclusively represents Mg, Ca, Sr and Ba, provided that these satisfy the following: MgO: 0 to 3 wt %, CaO: 0 to 3 wt %, SrO: 0 to 5 wt %, BaO: 0 to 5 wt %)

ZnO: 0 to 6 wt %

Ag: 0.4 to 1.5 wt %

Cl: 0.1 to 1.0 wt %

Br: 0.01 to 0.5 wt %, and

F: 0 to 0.2 wt %.

(4) The method for production of one of the above (1) to (3), wherein x is not less than 0.5 in the AgClₓBr₁₋ₓ crystals.

(5) The method for production of one of the above (1) to (4), wherein Ag, Br and F contained in the polarizing glass satisfy the following relation: Ag×(Br—F)≦0.1 in wt %.

(6) The method for production of the above (5), wherein the extinction ratio of the polarizing glass is not less than 10 dB.

(7) A polarizing glass produced by the method for production of one of the above (1) to (6).

(8) A polarizing glass comprising geometrically anisotropic metallic silver particles dispersed and oriented at least in a surface layer thereof,

wherein the polarizing glass does not contain TiO₂ exceeding 1.7 wt %, but contains not less than 0.4 wt % Ag, and

wherein, at 633 nm, the loss is not more than 0.6 dB, and the extinction ratio is not less than 35 dB, and

wherein Ag and halogens contained in the polarizing glass satisfy the following relations:

the molar ratio of Ag/(Cl+Br) is 0.2 to 1.0,

the molar ratio of Cl/(Cl+Br+F) is 0.5 to 0.95, and

the molar ratio of Br/(Cl+Br+F) is 0.05 to 0.4.

(9) A polarizing glass comprising geometrically anisotropic metallic silver particles dispersed and oriented at least in a surface layer thereof,

wherein the polarizing glass does not contain TiO₂ exceeding 1.7 wt %, but contains not less than 0.4 wt % Ag, and

wherein, at 532 nm, the loss is not more than 2.5 dB, and the extinction ratio is not less than 30 dB, and

wherein Ag and halogens contained in the polarizing glass satisfy the following relations:

the molar ratio of Ag/(Cl+Br) is 0.2 to 1.0,

the molar ratio of Cl/(Cl+Br+F) is 0.5 to 0.95, and

the molar ratio of Br/(Cl+Br+F) is 0.05 to 0.4.

(10) The polarizing glass of the above (8) or (9), wherein halogens contained in the polarizing glass satisfy the following relation: the molar ratio of F/(Cl+Br+F) is 0 to 0.4.

(11) The polarizing glass of one of the above (8) to (10), wherein the composition of the polarizing glass comprises

SiO₂: 40 to 63 wt %

B₂O₃: 15 to 26 wt %

Al₂O₃: 5 to 15 wt %

ZrO₂: 7 to 12 wt %

R¹₂O: 4 to 16 wt %

(wherein, R¹ inclusively represents Li, NaK and Cs, provided that these satisfy the following: Li₂O: 0 to 5 wt %, Na₂O: 0 to 9 wt %, K₂O: 0 to 12 wt %, Cs₂O: 0 to 6 wt %)

R²O: 0 to 7 wt %

(wherein, R² inclusively represents Mg, Ca, Sr and Ba, provided that these satisfy the following: MgO: 0 to 3 wt %, CaO: 0 to 3 wt %, SrO: 0 to 5 wt %, BaO: 0 to 5 wt %)

ZnO: 0 to 6 wt %

Ag: 0.4 to 1.5 wt %

Cl: 0.1 to 1.0 wt %

Br: 0.01 to 0.5 wt %, and

F: 0 to 0.2 wt %.

(12) The polarizing glass of one of the above (8) to (11), wherein Ag and halogens contained in the polarizing glass satisfy the following relation: Ag×(Br—F)≦0.1 in wt %.

(13) The polarizing glass of one of the above (8) to (12), wherein the extinction ratio of the polarizing glass is not less than 10 dB.

### Effect of Invention

According to the present invention as defined above, the liquid phase temperature during the formation of the mother glass (which is the temperature at which crystals start to precipitate in the glass as the high temperature melt is slowly cooled down) can be lowered, in spite of its high Ag content as compared with conventional mother glasses, thereby making it possible to prevent devitrification of the mother glass from taking place. It also makes it possible to raise the crystallization temperature, which is the temperature at which crystals start to precipitate in the glass as the glass is heated from a low temperature. This can prevent once-drawn silver halide crystals from respheroidizing in the softening and drawing process of the glass. Therefore, the present invention facilitates to provide a polarizing glass containing Ag at a high concentration, and thus, makes it easy to produce a polarizing glass having a high extinction ratio and suitable for various wavelengths within the visible region (in particular, 460 nm or longer) and the infrared region (for example, up to maximum 5000 nm.)

### BRIEF DESCRIPTION OF DRAWINGS

FIG. 1 is a graph showing the relation between aspect ratio and maximum absorption wavelength.

FIG. 2 Absorption cross section curves for silver particles of the same volume whose aspect ratios are 2:1 and 11:1.

FIG. 3 A graph showing the relation between the heat treatment temperature and the mean particle diameter in glasses exemplified in Comparative Examples 1 to 4.

FIG. 4 A photograph showing a polarization microscope image of a cross section of the polarizing glass of Example 1.

FIG. 5 A photograph showing a scanning electron microscope image of a cross section of the glass after drawn in Example 1. Elongated, and spindle-shaped shadows are holes which have been generated as a result of selective dissolution by etching of silver halide particles which were drawn.

FIG. 6 Spectral transmittance curves for the polarizing glass of Example 1.

FIG. 7 Spectral transmittance curves for the polarizing glass of Example 20

FIG. 8 Spectral transmittance curves for the polarizing glass of Example 21

### DESCRIPTION OF EMBODIMENTS

In the present invention, the term “geometrically anisotropic” as used with regard to a particle means that the ratio of the major axis/the minor axis (aspect ratio) of the particle, which is a generally spindle-shaped spheroid, is 1.4/1 or greater.

In the present invention, the term “oriented” as used with regard to anisotropic metallic silver particles means that there is a particular direction to which the distribution of the orientation of the numerous anisotropic metallic silver particles contained in a polarizing glass is biased as a whole (i.e., being not isotropic).

In the present invention, “extinction ratio” means P2/P1, wherein P1, the minimum transmitted light power, and P2, the maximum transmitted light power, are measured by introducing linearly polarized light perpendicularly into a polarizing glass and rotating the glass around its perpendicular axis. It is also given by the following equation (6) in decibel (dB).

[Math 7]

Extinction ratio (dB)=10·log₁₀(P₂/P₁) (7)

The composition of the polarizing glass of the present invention is described in more detail below. While SiO₂ improves weather resistance of a glass, it has an effect to make the glass less meltable. In view of these, the content of SiO₂ is preferably 40 to 63 wt %, more preferably 40 to 60 wt %, still more preferably 42 to 60 wt %.

B₂O₃ promotes precipitation of silver halide particles, but deteriorates weather resistance of a glass. In consideration of these, the content of B₂O₃ is preferably 15 to 26 wt %, more preferably from 16 to 25 wt %.

Al₂O₃ is a component which remarkably improves weather resistance of a glass.

It is, therefore, the more preferable in this respect to include this component in the larger amount. The component, on the other hand, makes the glass less meltable, and as a result, also acts to make the glass more prone to devitrification. For weather resistance, the content of Al₂O₃ must not be less than 5 wt %. In order to ensure satisfactory melting of the glass, on the other hand, the Al₂O₃ content is preferably not more than 15 wt %, more preferably not more than 12 wt %, and still more preferably not more than 10 wt %.

ZrO₂ is a component which remarkably improves weather resistance of a glass, and therefore, in this respect, it is the more preferable to include this component in the larger amount. The component, on the other hand, makes the glass less meltable, and as a result, also acts to make the glass more prone to devitrification. For weather resistance, the content of ZrO₂ must not be less than 7 wt %. In order to suppress devitrification, on the other hand, the ZrO₂ content must be not more than 12 wt %, and is preferably not more than 10 wt %.

TiO₂ has an effect to improve weather resistance of a glass and also to raise its refractive index. TiO₂ also has ultraviolet light-absorption ability and therefore contributes to inhibition of photochromism, but it has a strong effect to form nuclei in a glass and thus make the glass more prone to devitrification. In particular, TiO₂-induced devitrification highly depends on TiO₂ content, and occurs irrespective of the mutual ratios of halogen species as described below. Even if TiO₂ is contained, its content therefore must not be more than 1.7 wt %. It is preferably as less as possible if a high refractive index of glass is not needed.

An alkali metal oxide, R¹₂O (wherein R¹ inclusively represents Li, Na, K and Cs), greatly affects weather resistance and silver halide-induced devitrification. Namely, R¹₂O content is preferably as less as possible for improving weather resistance, but too little a content of it makes the glass less meltable and acts to render it more prone to devitrification. In consideration of these, it is preferable that the total R¹₂O content is 4 to 16 wt % and that, as a breakdown for each oxide, the content is 0 to 5 wt % for Li₂O, 0 to 9 wt % for Na₂O, 0 to 12 wt % for K₂O, and 0 to 6 wt % for Cs₂O, respectively. An increased number of alkali metal species contained serves to improve weather resistance by their mixed alkali effect. It is therefore advantageous to include each of the above alkali metals by a small amount. But it is also allowed not to include Cs₂O, for this is expensive. Accordingly, preferable content of each oxide is 0 to 4 wt % for Li₂O, 0 to 8 wt % for Na₂O and 0 to 10 wt % for K₂O, and more preferably, 0 to 3 wt % for Li₂O, 0 to 6 wt % for Na₂O and 0 to 9 wt % for K₂O, respectively.

An alkaline earth metal, R²O, exerts a remarkable influence on improvement of phase separability and weather resistance. R²O, though not indispensable, may be contained at an amount of from 0 to 7 wt %. As a breakdown for each oxide, their content is preferably 0 to 3 wt % for MgO, 0 to 3 wt % for CaO, 0 to 5 wt % for SrO, and 0 to 5 wt % for BaO. As alkaline earth metal also brings about a mixed alkali effect, it is advantageous to include many of them by a small amount each, in order to improve weather resistance. Among the alkaline earth metals, MgO particularly has an effect of making viscosity-temperature curve of the glass relatively gentle, i.e., making it so-called a long glass, thereby giving a favorable effect on working efficiency in a drawing process.

ZnO may be included because it improves weather resistance and has an effect of making a glass “long”, but too much a content of ZnO would make the glass prone to devitrification. In view of these, it is preferable that the ZnO content is 0 to 6 wt %.

In order to achieve a high extinction ratio, it is advantageous to increase Ag content. In particular, when reduction treatment is conducted at 1 atm, the Ag content is preferably not less than 0.4 wt %, more preferably not less than 0.42 wt %, and still more preferably not less than 0.45 wt %. Further, it is more preferable for a polarizer for the visible region that the Ag content is not less than 0.5 wt %. Too high a Ag content, however, makes it difficult to suppress devitrification no matter how halogen ratios are adjusted. Therefore, its content is preferably not more than 1.5 wt %, more preferably not more than 1.2 wt %.

It is necessary that the total content of Cl and Br is greater than that of Ag in order to prevent silver halide particles in the glass from being spontaneously reduced to metallic silver particles before conducting the reduction process. In molar ratio, Ag/(Cl+Br) is preferably 0.2 to 1.0, more preferably 0.3 to 0.8, still more preferably 0.4 to 0.7. Herein, F, among halogen species, is excluded, for AgF crystals are thermally instable and cannot be precipitated.

Halogen content has the greatest effect on precipitation of silver halide particles. It is preferable that

the content of Cl is 0.1 to 1.0 wt %, Br 0.01 to 0.5 wt %, and F 0 to 0.2 wt %, and,

in wt %, Ag×(Br—F)≦0.1, and,

in molar ratio, Cl/(Cl+Br+F) is 0.5 to 0.95, Br/(Cl+Br+F) 0.05 to 0.4, and F/(Cl+Br+F) 0 to 0.4.

Among the halogen species, the component that has the largest ratio is Cl. The Cl content is preferably 0.1 to 1.0 wt % as mentioned above, more preferably 0.15 to 0.7 wt %, still more preferably 0.2 to 0.6 wt %. The molar ratio among halogen species, Cl/(Cl+Br+F), is preferably 0.5 to 0.95, more preferably 0.5 to 0.9, still more preferably 0.55 to 0.85.

By adding Br, a mixed mobile ion effect occurs between Cl and Br, which enables to lower the diffusion rate of halogen. A lower diffusion rate facilitates to control the particle size as well as serves to prevent, through raising the crystallizing temperature, silver halide from respheroidizing induced by diffusion of halogen during the drawing process. For this purpose, the Br content is preferably 0.01 to 0.5 wt %, more preferably 0.03 to 0.3 wt %, still more preferably 0.05 to 0.25 wt %. For the mixed mobile ion effect to take place, the molar ratio of Br/(Cl+Br+F) is preferably 0.05 to 0.4, more preferably 0.05 to 0.35, still more preferably 0.05 to 0.25.

Br, however, also has effects of raising the liquid phase temperature and making the glass more prone to devitrification. The major factor for devitrification here is the low solubility of Br. The present inventors have found that the rate of precipitation of AgBr crystals is proportional to both concentrations of Ag and Br, and that devitrification, when F is not present, can be inhibited by adjusting Ag and Br, in wt %, to satisfy Ag×Br≦0.1.

Though addition of F reduces the liquid phase temperature, a mixed mobile ion effect between F and Cl works only weakly, and no effect on diffusion rate is observed only with F and Cl. Accordingly, a glass containing Cl and F but no Br is not preferable. Mixed ion mobile effect, however, works between F and Br, and therefore the diffusion rate of halogen becomes minimum when these three halogen species, F, Cl and Br, are all included.

Thus, by inclusion of F and thereby reducing the liquid phase temperature and further lowering the diffusion rate of halogen as well, it become possible to inhibit devitrification even if Ag and Br are included in the glass in greater amounts than those in conventional glasses. In this case, the present inventors have also found that a still better result can be obtained by adjusting Ag, Br and F, in wt %, to satisfy Ag×(Br—F)≦0.1Namely, as seen in the tables presented in the section of Examples, lowering the value of Ag×(Br—F) enables to produce such a glass having a high devitrification resistance as does not devitrify even subjected to a heat treatment at 900° C. for one hour.

However, there are some cases where excessive addition of F decreases the liquid phase temperature to too low a level, and as a result, inhibits precipitation of silver halide crystals. Thus, F content is preferably 0 to 0.2 wt %, more preferably 0 to 0.15 wt %, still more preferably 0 to 0.1 wt %. Moreover, in order for the mixed mobile ion effect to take place, F/(Cl+Br+F) is preferably 0 to 0.4, more preferably 0.01 to 0.3, still more preferably 0.05 to 0.3.

As shown in the section of Examples, as compared with a glass free of Br, there is a tendency that the mean particle diameter of precipitated silver halide particles is small and the diffusion rate of halogen is slow in a glass containing Br (FIG. 3).

It is seen that, in the same glass, the higher the temperature of the glass is, the larger the diameter of precipitated silver halide particles becomes. Further, since the silver halide particles are those which have precipitated in the glass and grow there, the mean diameter of them naturally has a tendency to become greater as the heat treatment is extended. Therefore, their particle diameter can be controlled by adjusting the temperature and duration of the treatment. The temperature of heat treatment is set at a temperature which is higher than the softening temperature by several decades ° C., and it may generally be set at 650 to 800° C. The duration of heat treatment may generally be one to 10 hours. In a simple way, one may determine a desired condition of heat treatment by preparing a glass sample, heat treating it at a temperature and for a length of time, for example, near the center of the above ranges, respectively, measuring the diameter of the silver halide particles in the glass obtained, and, if necessary, varying the temperature and duration of heat treatment. Thereafter, the same condition as determined above may be applied to the heat treatment as long as a glass of the same composition is treated.

If the ratio of Br in precipitating silver halide rises, the bandgap of the silver halide particles become narrow, thereby turning white glass yellow, the effect of which on absorption loss in the visible region can no longer be neglected. Therefore, in consideration of use in the visible region, “x”, in the silver halide particles AgClₓBr₁₋ₓ, is preferably not less than 0.5, and more preferably not less than 0.7.

The method for production of a polarizing glass of the present invention is described below. Various kinds of raw materials such as oxides, halides, hydroxides, nitrates, sulfates, carbonates, and the like are blended so that a mother glass composition may be obtained which meets the above-defined composition ranges, and this blend is melted by a conventional method. The glass melt is poured into a mold, where it is formed into a shape, and then silver halide particles are let precipitate by heat treatment.

Then, the heat-treated mother glass thus obtained is precision lapped to give a plate-like preform, and then this is drawn. The drawing is conducted at a temperature at which the viscosity of glass is 10⁶ to 10⁹ poise (P) and under a stress of 50 to 500 kgf/cm². By this drawing, silver halide particles in the glass are also drawn and become geometrically anisotropic. The drawing is carried out so that the aspect ratio of silver halide particles reaches at least 2:1 or greater. The aspect ratio, with which there is no particular upper limit, can be set as desired according to the purpose. Though the extent to which the drawing is conducted depends on the wavelength of interest to be used, the viscosity of the glass, and the stress to be applied, drawing may generally be conducted so that the length of the glass becomes about 2 to 1000 times longer, i.e., the cross sectional area becomes about ½ to 1/1000 times narrower. Such drawing may be conducted by a single process. In order to carry out drawing with a high draw ratio, however, it may be conducted in such a manner that the process is divided into two or more processes, where a glass which has passed through a first of such processes is portioned into pieces of proper sizes, and each piece is further subjected to the following drawing process(es). (The final draw ratio is given as the product of draw ratios in all the processes). The aspect ratio of silver halide particles in a drawn glass can be measured by, for example, scanning microscopy of a cross section of a sample. Therefore, a drawing condition for obtaining an intended aspect ratio can easily be found from aspect ratios of silver halide particles in glasses obtained under properly altered conditions.

For example, in order to obtain a polarizing glass having its maximum absorption in an infrared region such as 1300 to 1600 nm, drawing may be carried out so that the cross-sectional area becomes 1/20 to 1/50 after drawing, by applying a stress of 200 to 400 kgf/cm² when the viscosity is, for example, 10⁸ P. Viscosity can be measured using a commercially available viscosity measuring apparatus. (For example, measured by the parallel plate method with a wide range viscometer, WRVM-313 manufactured by OPT Corporation).

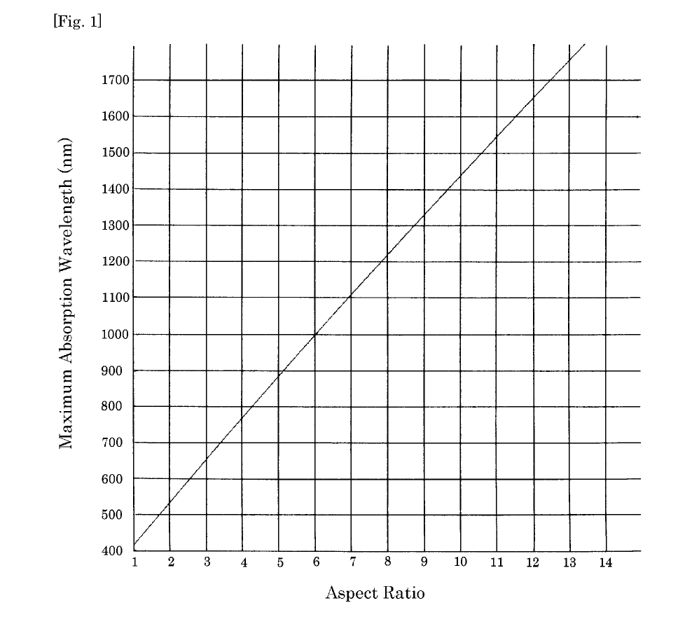

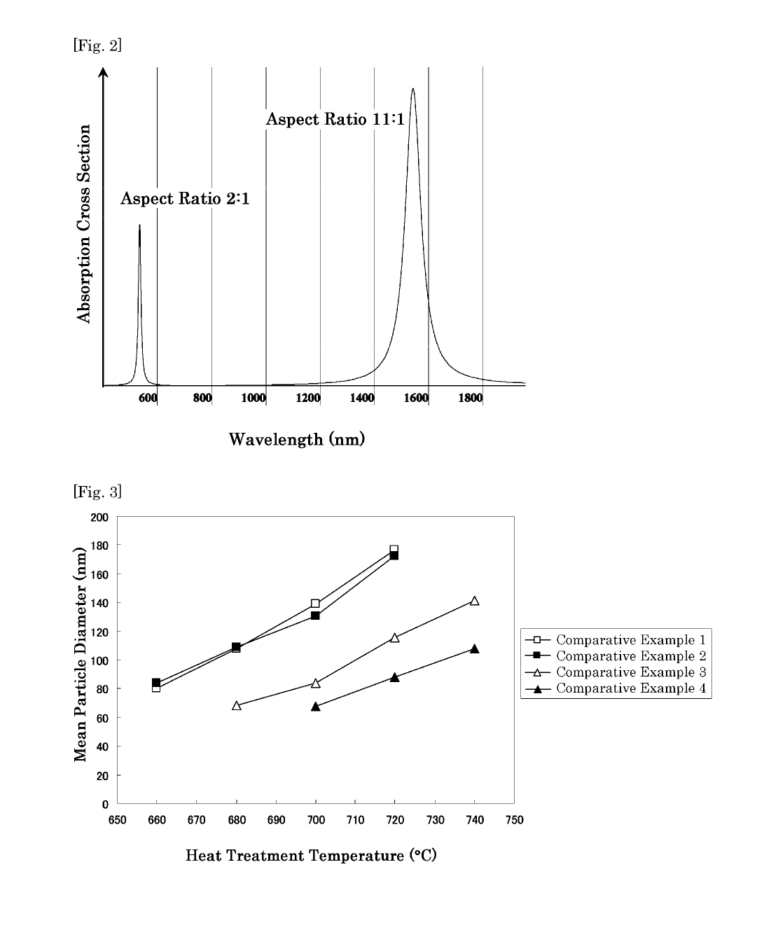

As described above, there is the relation shown in FIG. 1 between the maximum absorption wavelength λₘₐₓ of a polarizing glass and the aspect ratio of the metallic silver particles contained in the glass. Therefore, in order to obtain, for example, a polarizing glass exhibiting the maximum absorption wavelength, λₘₐₓ, at a wavelength in the visible region, it is sufficient to regulate drawing so that the aspect ratio of the metallic silver particles in the glass falls within a smaller range than that of a polarizing glass exhibiting the maximum absorption λₘₐₓ in the infrared region, thereby causing the glass to exhibit its maximum absorption at a shorter wavelength than infrared light. This can be achieved by application of lower drawing stress than that with which a polarizing glass for the infrared region is made of the same mother glass.

The drawn glass is subjected to reduction treatment in a hydrogen atmosphere at a temperature not higher than its glass transition point. In the present invention, there is no need to pressurize the hydrogen atmosphere, and the reduction treatment can be carried out effectively under a non-increased pressure (ambient pressure, i.e., one atm). By this reduction treatment, at least those geometrically anisotropic silver halide particles which exist in the surface layer of the glass are converted into geometrically anisotropic metallic silver particles. The glass thus obtained, containing geometrically anisotropic metallic silver at least in its surface layer, exhibits a polarizing property. Herein, the phrase “containing . . . at least in its surface layer” used regarding geometrically anisotropic metallic silver particles merely states that it is not required that the silver halide particles in the central region of the glass be converted into metallic silver particles, and thus does not mean that a “surface layer” must be a layer of some particular thickness. Namely, it is sufficient that geometrically anisotropic metallic silver particles are contained at least in the surface layer side to some depth.

### EXAMPLES

In the following, the method for production of a polarizing glass of the present invention is described with reference to examples. It is, however, not intended that the present invention be limited to the examples.

### Examples 1 to 171

### Preparation of Mother Glass

Mother glasses consisting of the compositions according to Examples 1 to 17 shown in Tables 1-1 to 2-2 were prepared. Namely, raw materials which had been mixed so as to give each composition were melted in a 500-cc platinum crucible at a temperature of 1450 to 1600° C., poured into a mold, cooled to a temperature below the glass transition point to give mother glass blocks. In tables, “Devitrification” indicates whether or not devitrification occurred in each mother glass block.

The mother glass blocks in these examples were heat treated for 2 to 8 hours in an electric furnace maintained at a temperature of 700 to 760° C. as shown in the above tables to produce heat-treated mother glass blocks. These heat-treated mother glasses were found turbid, tinted with white or yellow, due to precipitated silver halide crystals. No photochromism of glass by irradiation with ultraviolet light was observed in any of these glasses. “Heat treatment at 900° C.” indicates whether or not turbidity occurred after heat treatment at 900° C. for one hour.

Particle diameter of the precipitated silver halide crystals was measured of the heat treated mother glasses. The procedure of measurement is as follows. Namely, a heat treated mother glass was fractured to give a smooth surface. The smooth surface obtained was etched with 5 wt % HF aqueous solution for 15 minutes. Spherical pores, which were formed by selective dissolution of the parts consisting of precipitated particles, were observed with a scanning electron microscope (SEM).

### DRAWING

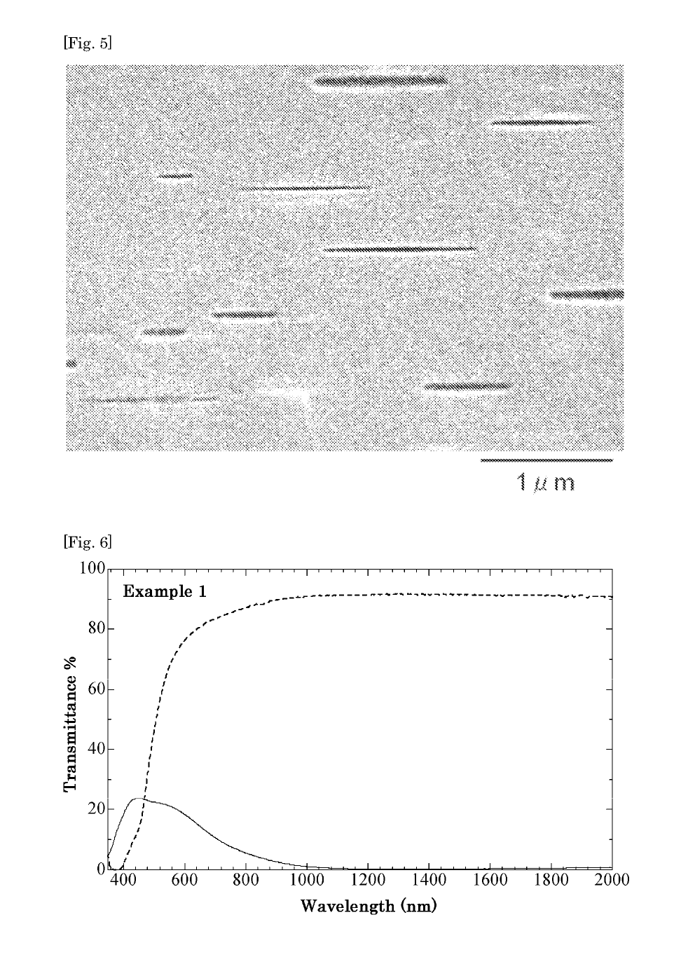

The heat-treated mother glasses in Example 1 to 17 were shaped into 60×500×5 mm to give preforms. The preforms were heated to a temperature at which their viscosity was about 10⁸ P, and drawn by applying a tensile stress of about 300 to 350 kgf/cm². The cross sectional area after drawing was about 1/27 to 1/43 of that before drawing, and the aspect ratios of silver halide particles then were about 5:1 to 25:1. As an example, a scanning electron microscope image of a cross section of the drawn glass in Example 1 is shown in FIG. 5. This is an image obtained after fracturing the glass in the direction parallel to the direction of the draw and etching it with 5 wt % HF aqueous solution for 15 minutes.

### <Reduction Treatment>

The drawn glasses were cut into 10 mm squares, which were precision lapped to 0.2 mm thickness, and subjected to a hydrogen reduction treatment. The reduction treatment was carried out at 460° C. for 4 hours in the flow of 100% hydrogen gas at a flow rate of 10 ml/minute under ambient pressure.

### <Assessment>

Extinction ratios of thus obtained polarizing glasses were measured at two wavelength points of 1310 nm and 1550 nm. An antireflection film was provided on the surface of each polarizing glass for measurement of extinction ratio. A collimator beam which was made linearly polarized light through a Glan-Thompson Prism was introduced into a polarizing glass, and, while rotating the polarizing glass, the minimum transmitted light power, P₁, and the maximum transmitted light power, P₂, were measured. The extinction ratio was calculated according to equation (7) mentioned above. P₀ was measured, which was the light power without a polarizing glass at the position at which the above mentioned transmitted light powers were measured at each wavelength. Insertion losses (expressed in dB) at the same wavelengths were calculated according to the following equation (8).

[Math 8]

Insertion loss (dB)=log₁₀(P₀/P₂) (8)

The value of x in silver halide crystals, AgClₓBrₓ₋₁, was determined by powder X-ray diffraction. The value was obtained based on Vegard's law, calculating lattice constant from diffracted beams.

The composition (wt %) of each glass and the result of measurements are shown in the following Tables.

TABLE 1-1

| | Example 1 | | Example 2 | | Example 3 | | Example 4 | | Example 5 | |
|---|---|---|---|---|---|---|---|---|---|---|
| SiO₂ | 54.6 | | 50.3 | | 45.7 | | 46.8 | | 49.4 | |
| B₂O₃ | 18.4 | | 21.0 | | 25.1 | | 20.5 | | 22.3 | |
| Al₂O₃ | 6.4 | | 7.3 | | 6.1 | | 5.1 | | 8.7 | |
| ZrO₂ | 7.8 | | 8.3 | | 7.0 | | 9.8 | | 7.0 | |
| TiO₂ | — | | — | | — | | — | | — | |
| Li₂O | 1.7 | | 1.7 | | 2.6 | | 2.6 | | 1.5 | |
| Na₂O | 3.3 | | 4.7 | | 0.9 | | 2.7 | | 5.0 | |
| K₂O | 6.8 | | 5.6 | | 4.6 | | 3.3 | | 5.0 | |
| MgO | — | | — | | — | | — | | — | |
| CaO | — | | — | | 0.8 | | — | | — | |
| SrO | — | | — | | 1.6 | | 1.5 | | — | |
| BaO | — | | — | | — | | 2.3 | | — | |
| ZnO | — | | — | | 4.9 | | 4.8 | | — | |
| Ag | 0.61 | | 0.52 | | 0.41 | | 0.40 | | 0.60 | |
| Cl | 0.35 | | 0.27 | | 0.22 | | 0.22 | | 0.31 | |
| Br | 0.08 | | 0.20 | | 0.12 | | 0.12 | | 0.10 | |
| F | 0.06 | | 0.05 | | 0.06 | | 0.07 | | 0.05 | |
| CuO | — | | — | | — | | — | | — | |
| CeO₂ | — | | — | | — | | — | | — | |
| Ag × (Br − F) | 0.01 | | 0.08 | | 0.02 | | 0.02 | | 0.03 | |
| Molar ratio Ag/(Cl + Br) | 0.52 | | 0.48 | | 0.49 | | 0.48 | | 0.56 | |
| Molar ratio Cl/(Cl + Br + F) | 0.70 | | 0.60 | | 0.57 | | 0.54 | | 0.69 | |
| Molar ratio Br/(Cl + Br + F) | 0.07 | | 0.20 | | 0.14 | | 0.13 | | 0.10 | |
| Molar ratio F/(Cl + Br + F) | 0.23 | | 0.21 | | 0.29 | | 0.32 | | 0.21 | |
| Devitrification | not | | not | | not | | not | | not | |
| Condition of heat treatment | 730° C. 4 hr | | 720° C. 4 hr | | 720° C. 4 hr | | 740° C. 4 hr | | 720° C. 4 hr | |
| Mean particle diameter | 90 | nm | 100 | nm | 90 | nm | 80 | nm | 100 | nm |
| Appearance after heat | white | | white | | yellow | | yellow | | white | |
| treatment | | | | | | | | | | |
| AgClₓBr₁₋ₓ | x = 0.74 | | x = 0.65 | | x = 0.51 | | x = 0.46 | | x = 0.80 | |
| Heat treatment at 900° C. | turbid | | turbid | | transparent | | transparent | | transparent | |
| Temperature during drawing | 660° | C. | 630° | C. | 640° | C. | 640° | C. | 650° | C. |
| Tensile stress | 330 kgf/cm² | | 320 kgf/cm² | | 310 | kgf/cm² | 340 | kgf/cm² | 340 | kgf/cm² |
| Cross sectional area ratio | 1/34 | | 1/35 | | 1/36 | | 1/43 | | 1/40 | |
| after drawing*¹ | | | | | | | | | | |
| Reduction condition | 460° C. 4 hr | | 460° C. 4 hr | | 460° C. 4 hr | | 460° C. 4 hr | | 460° C. 4 hr | |
| Extinction ratio at 1550 nm | not less | | not less | | 56 | dB | 58 | dB | not less | |
| | than 60 dB | | than 60 dB | | | | | | than 60 dB | |
| Insertion loss at 1550 nm | 0.03 | dB | 0.03 | dB | 0.03 | dB | 0.03 | dB | 0.03 | dB |
| Extinction ratio at 1310 nm | not less | | not less | | not less | | 55 | dB | not less | |
| | than 60 dB | | than 60 dB | | than 60 dB | | | | than 60 dB | |
| Insertion loss at 1310 nm | 0.03 | dB | 0.03 | dB | 0.03 | dB | 0.03 | dB | 0.03 | dB |

*¹Cross sectional area after drawing/Cross sectional area before drawing

TABLE 1-2

| | Example 6 | | Example 7 | | Example 8 | | Example 9 | |
|---|---|---|---|---|---|---|---|---|
| SiO₂ | 43.3 | | 51.7 | | 49.8 | | 50.5 | |
| B₂O₃ | 22.6 | | 21.3 | | 21.8 | | 20.3 | |
| Al₂O₃ | 9.2 | | 5.9 | | 5.3 | | 6.7 | |
| ZrO₂ | 7.0 | | 8.5 | | 8.3 | | 8.5 | |
| TiO₂ | — | | 1.0 | | — | | 0.8 | |
| Li₂O | 0.4 | | 2.3 | | 1.5 | | 1.7 | |
| Na₂O | 4.4 | | 3.8 | | 3.3 | | 4.6 | |
| K₂O | 6.7 | | 4.6 | | 6.0 | | 5.3 | |
| MgO | — | | — | | 1.0 | | — | |
| CaO | — | | — | | — | | — | |
| SrO | — | | — | | — | | — | |
| BaO | 4.3 | | — | | — | | — | |
| ZnO | 1.2 | | — | | 2.2 | | 0.7 | |
| Ag | 0.70 | | 0.48 | | 0.48 | | 0.47 | |
| Cl | 0.33 | | 0.24 | | 0.24 | | 0.31 | |
| Br | 0.05 | | 0.13 | | 0.18 | | 0.10 | |
| F | 0.05 | | 0.07 | | — | | 0.02 | |
| CuO | — | | — | | — | | — | |
| CeO₂ | — | | — | | — | | — | |
| Ag × (Br − F) | 0.00 | | 0.03 | | 0.09 | | 0.04 | |
| Molar ratio Ag/(Cl + Br) | 0.65 | | 0.53 | | 0.49 | | 0.44 | |
| Molar ratio Cl/(Cl + Br + F) | 0.74 | | 0.56 | | 0.75 | | 0.79 | |
| Molar ratio Br/(Cl + Br + F) | 0.05 | | 0.13 | | 0.25 | | 0.11 | |
| Molar ratio F/(Cl + Br+ F) | 0.21 | | 0.30 | | 0.00 | | 0.10 | |
| Devitrification | not | | not | | not | | not | |
| Condition of heat treatment | 720° C. 8 hr | | 720° C. 4 hr | | 720° C. 4 hr | | 700° C. 4 hr | |
| Mean particle diameter | 80 | nm | 90 | nm | 90 | nm | 90 | nm |
| Appearance after heat | white | | white | | white | | white | |
| treatment | | | | | | | | |
| AgClₓBr₁₋ₓ | x = 0.91 | | x = 0.74 | | x = 0.70 | | x = 0.76 | |
| Heat treatment at 900° C. | transparent | | transparent | | turbid | | turbid | |
| Temperature during drawing | 660° | C. | 650° | C. | 630° | C. | 640° | C. |
| Tensile stress | 340 kgf/cm² | | 340 | kgf/cm² | 330 | kgf/cm² | 320 | kgf/cm² |
| Cross sectional area ratio | 1/38 | | 1/35 | | 1/34 | | 1/33 | |
| after drawing*¹ | | | | | | | | |
| Reduction condition | 460° C. 4 hr | | 460° C. 4 hr | | 460° C. 4 hr | | 460° C. 4 hr | |
| Extinction ratio at 1550 nm | not less | | not less | | not less | | not less | |
| | than 60 dB | | than 60 dB | | than 60 dB | | than 60 dB | |
| Insertion loss at 1550 nm | 0.03 | dB | 0.03 | dB | 0.03 | dB | 0.03 | dB |
| Extinction ratio at 1310 nm | not less | | not less | | not less | | 56 | dB |
| | than 60 dB | | than 60 dB | | than 60 dB | | | |
| Insertion loss at 1310 nm | 0.03 | dB | 0.03 | dB | 0.03 | dB | 0.03 | dB |

*¹Cross sectional area after drawing/Cross sectional area before drawing

TABLE 2-1

| | Example 10 | | Example 11 | | Example 12 | | Example 13 | |
|---|---|---|---|---|---|---|---|---|
| SiO₂ | 51.7 | | 50.8 | | 52.9 | | 58.6 | |
| B₂O₃ | 22.1 | | 23.6 | | 19.9 | | 16.5 | |
| Al₂O₃ | 7.2 | | 6.9 | | 7.7 | | 6.1 | |
| ZrO₂ | 8.7 | | 7.6 | | 7.4 | | 7.1 | |
| TiO₂ | — | | — | | — | | — | |
| Li₂O | 1.2 | | 2.9 | | 1.5 | | — | |
| Na₂O | 4.3 | | 3.5 | | 2.9 | | — | |
| K₂O | — | | 3.3 | | 1.7 | | 8.8 | |
| MgO | 2.1 | | — | | 0.6 | | — | |
| CaO | 0.9 | | — | | — | | 1.7 | |
| SrO | — | | — | | 3.4 | | — | |
| BaO | — | | — | | — | | — | |
| ZnO | — | | — | | 1.2 | | — | |
| Ag | 1.14 | | 0.72 | | 0.49 | | 0.74 | |
| Cl | 0.55 | | 0.39 | | 0.28 | | 0.39 | |
| Br | 0.13 | | 0.13 | | 0.12 | | 0.06 | |
| F | 0.04 | | 0.04 | | 0.04 | | 0.09 | |
| CuO | — | | — | | — | | — | |
| CeO₂ | — | | — | | — | | — | |
| Ag × (Br − F) | 0.10 | | 0.06 | | 0.04 | | −0.02 | |
| Molar ratio Ag/(Cl + Br) | 0.62 | | 0.53 | | 0.48 | | 0.58 | |
| Molar ratio Cl/(Cl + Br + F) | 0.81 | | 0.75 | | 0.69 | | 0.67 | |
| Molar ratio Br/(Cl + Br + F) | 0.08 | | 0.11 | | 0.13 | | 0.05 | |
| Molar ratio F/(Cl + Br + F) | 0.11 | | 0.14 | | 0.18 | | 0.29 | |
| Devitrification | not | | not | | not | | not | |
| Condition of heat treatment | 700° C. 2 hr | | 720° C. 2 hr | | 720° C. 2 hr | | 760° C. 4 hr | |
| Mean particle diameter | 140 | nm | 120 | nm | 120 | nm | 90 | nm |
| Appearance after heat | white | | white | | white | | white | |
| treatment | | | | | | | | |
| AgClₓBr₁₋ₓ | x = 0.90 | | x = 0.72 | | x = 0.96 | | x = 0.76 | |
| Heat treatment at 900° C. | turbid | | turbid | | transparent | | turbid | |
| Temperature during drawing | 660° | C. | 650° | C. | 650° | C. | 670° | C. |
| Tensile stress | 320 | kgf/cm² | 320 | kgf/cm² | 340 | kgf/cm² | 340 | kgf/cm² |
| Cross sectional area ratio | 1/27 | | 1/37 | | 1/40 | | 1/32 | |
| after drawing*¹ | | | | | | | | |
| Reduction condition | 460° C. 4 hr | | 460° C. 4 hr | | 460° C. 4 hr | | 460° C. 4 hr | |
| Extinction ratio at 1550 nm | not less | | not less | | not less | | not less | |
| | than 60 dB | | than 60 dB | | than 60 dB | | than 60 dB | |
| Insertion loss at 1550 nm | 0.05 | dB | 0.03 | dB | 0.04 | dB | 0.03 | dB |
| Extinction ratio at 1310 nm | not less | | not less | | not less | | not less | |
| | than 60 dB | | than 60 dB | | than 60 dB | | than 60 dB | |
| Insertion loss at 1310 nm | 0.04 | dB | 0.03 | dB | 0.04 | dB | 0.03 | dB |

*¹Cross sectional area after drawing/Cross sectional area before drawing

TABLE 2-2

| | Example 14 | | Example 15 | | Example 16 | | Example 17 | |
|---|---|---|---|---|---|---|---|---|
| SiO₂ | 49.0 | | 53.0 | | 54.2 | | 49.5 | |
| B₂O₃ | 19.1 | | 19.1 | | 16.7 | | 21.7 | |
| Al₂O₃ | 8.2 | | 6.1 | | 7.1 | | 6.8 | |
| ZrO₂ | 8.2 | | 7.9 | | 7.0 | | 8.1 | |
| TiO₂ | — | | 1.1 | | 0.2 | | 1.5 | |
| Li₂O | 1.5 | | 2.1 | | 1.8 | | 1.4 | |
| Na₂O | 6.0 | | 3.3 | | 2.8 | | 2.8 | |
| K₂O | 4.7 | | 2.9 | | 3.1 | | 4.2 | |
| MgO | — | | 1.1 | | 0.9 | | — | |
| CaO | — | | 1.0 | | 0.8 | | — | |
| SrO | — | | 0.7 | | 1.2 | | 3.1 | |
| BaO | — | | 0.7 | | 1.4 | | — | |
| ZnO | 2.4 | | — | | 1.7 | | — | |
| Ag | 0.55 | | 0.56 | | 0.57 | | 0.48 | |
| Cl | 0.29 | | 0.33 | | 0.31 | | 0.23 | |
| Br | 0.11 | | 0.12 | | 0.13 | | 0.12 | |
| F | 0.07 | | 0.04 | | 0.02 | | — | |
| CuO | — | | — | | — | | — | |
| CeO₂ | — | | — | | — | | — | |
| Ag × (Br − F) | 0.02 | | 0.04 | | 0.06 | | 0.06 | |
| Molar ratio Ag/(Cl + Br) | 0.53 | | 0.48 | | 0.51 | | 0.56 | |
| Molar ratio Cl/(Cl + Br + F) | 0.62 | | 0.72 | | 0.77 | | 0.81 | |
| Molar ratio Br/(Cl + Br + F) | 0.10 | | 0.12 | | 0.14 | | 0.19 | |
| Molar ratio F/(Cl + Br + F) | 0.28 | | 0.16 | | 0.09 | | 0.00 | |
| Devitrification | not | | not | | not | | not | |
| Condition of heat treatment | 700° C. 4 hr | | 720° C. 8 hr | | 740° C. 8 hr | | 700° C. 4 hr | |
| Mean particle diameter | 110 | nm | 80 | nm | 80 | nm | 110 | nm |
| Appearance after heat | white | | white | | white | | white | |
| treatment | | | | | | | | |
| AgClₓB₁₋ₓ | x = 0.72 | | x = 0.75 | | x = 0.78 | | x = 0.81 | |
| Heat treatment at 900° C. | turbid | | turbid | | turbid | | turbid | |
| Temperature during drawing | 640° | C. | 650° | C. | 660° | C. | 660° | C. |
| Tensile stress | 310 | kgf/cm² | 340 | kgf/cm² | 340 | kgf/cm² | 340 | kgf/cm² |
| Cross sectional area ratio | 1/29 | | 1/34 | | 1/30 | | 1/30 | |
| after drawing*¹ | | | | | | | | |
| Reduction condition | 460° C. 4 hr | | 460° C. 4 hr | | 460° C. 4 hr | | 460° C. 4 hr | |
| Extinction ratio at 1550 nm | not less | | not less | | not less | | not less | |
| | than 60 dB | | than 60 dB | | than 60 dB | | than 60 dB | |
| Insertion loss at 1550 nm | 0.03 | dB | 0.03 | dB | 0.03 | dB | 0.03 | dB |
| Extinction ratio at 1310 nm | not less | | not less | | not less | | not less | |
| | than 60 dB | | than 60 dB | | than 60 dB | | than 60 dB | |
| Insertion loss at 1310 nm | 0.04 | dB | 0.03 | dB | 0.03 | dB | 0.03 | dB |

*¹Cross sectional area after drawing/Cross sectional area before drawing

As shown in these tables, by using compositions with high Ag content, glasses having a preferable polarizing property were obtained, with their extinction ratios after formation of an antireflection film on them being not less than 56 dB, at both wavelengths of 1310 nm and 1550 nm, even though they were the products for which reduction was carried out under the condition of ambient pressure at 460° C. for 4 hours. Also, their insertion losses were very small, i.e., 0.03 to 0.04 dB at 1310 nm and 0.03 to 0.05 dB at 1550 nm.

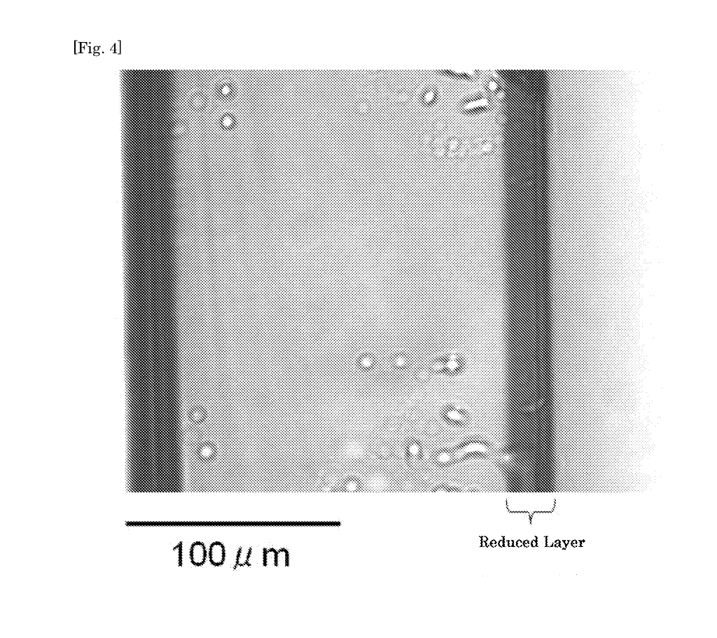

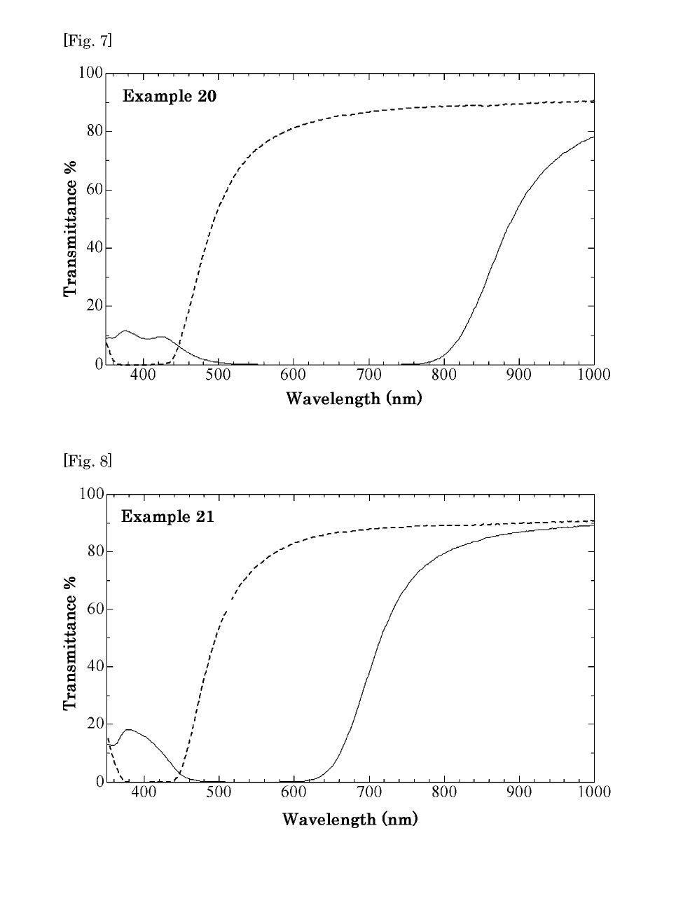

As an example, a polarization microscope image of a cross section of the polarizing glass of Example 1 is shown. (FIG. 4) Formation of reduced layers of about 25 μm thickness is observed in both surface regions of the polarizing glass. FIG. 6 shows spectral transmittance curves of the polarizing glass of Example 1, in which the spectral transmittance curve shown in solid line is the curve produced with linearly polarized light introduced at an angle at which the oscillating direction of the electric field of the light is parallel to the direction in which the glass was drawn, and the spectral transmittance curve shown in dotted line is the curve produced with linearly polarized light introduced at an angle at which the oscillating direction of the electric field is perpendicular to the direction of draw. (The same also applies in FIGS. 7 and 8). The figure shows that the glass obtained have excellent polarizing properties in the infrared region. Spectral transmittance curves of similar pattern were also produced for the glasses of Examples 2 to 17. (Data not shown.)

### Comparative Examples 1 to 5

Comparative Examples 1 to 5 presented in Table 3-1 show the glasses of the different compositions which were used to study the conditions for polarizing glass production. FIG. 3 compares mean diameters (number average diameter) of precipitated particles when the glasses having the compositions shown in Comparative Examples 1 to 4 were heat treated at various temperatures for 4 hours in order to examine the relation between temperatures of treatment and diameters of precipitated particles. These glasses differ only in the amount of halogen and the mutual ratio between halogen species while identical with regard to other components and their contents. Among them, it is seen that, in the glasses containing Br (Comparative Examples 3 and 4), average diameter is relatively small and diffusion rate of halogen is relatively slow. It is also seen from FIG. 3 that, in the same glass, the higher the temperature of heat treatment is, the larger becomes the diameter of the silver halide particles precipitated in the same period of time.

TABLE 3-1

| | Comparative | Comparative | Comparative | Comparative | Comparative |
|---|---|---|---|---|---|
| | Example 1 | Example 2 | Example 3 | Example 4 | Example 5 |
| SiO₂ | 49.8 | 49.8 | 49.7 | 49.7 | 53.4 |
| B₂O₃ | 21.8 | 21.8 | 21.8 | 21.8 | 19.2 |
| Al₂O₃ | 5.3 | 5.3 | 5.3 | 5.3 | 6.0 |
| ZrO₂ | 8.3 | 8.3 | 8.3 | 8.3 | 7.0 |
| TiO₂ | — | — | — | — | 2.0 |
| Li₂O | 1.5 | 1.5 | 1.5 | 1.5 | 2.0 |
| Na₂O | 3.3 | 3.3 | 3.3 | 3.3 | 2.6 |
| K₂O | 6.0 | 6.0 | 6.0 | 6.0 | 5.0 |
| MgO | 1.0 | 1.0 | 1.0 | 1.0 | 1.8 |
| CaO | — | — | — | — | — |
| SrO | — | — | — | — | — |
| BaO | — | — | — | — | — |
| ZnO | 2.2 | 2.2 | 2.2 | 2.2 | — |
| Ag | 0.48 | 0.48 | 0.48 | 0.48 | 0.60 |
| Cl | 0.40 | 0.24 | 0.22 | 0.24 | 0.26 |
| Br | — | — | 0.36 | 0.29 | 0.14 |
| F | — | 0.09 | — | 0.03 | 0.07 |
| CuO | — | — | — | — | — |
| CeO₂ | — | — | — | — | — |
| Ag × (Br − F) | 0.00 | −0.04 | 0.17 | 0.12 | 0.04 |
| Molar ratio Ag/(Cl + Br) | 0.39 | 0.66 | 0.42 | 0.43 | 0.61 |
| Molar ratio Cl/(Cl + Br + F) | 1.00 | 0.59 | 0.58 | 0.57 | 0.57 |
| Molar ratio Br/(Cl + Br + F) | 0.00 | 0.00 | 0.42 | 0.30 | 0.14 |
| Molar ratio F/(Cl + Br + F) | 0.00 | 0.41 | 0.00 | 0.13 | 0.29 |
| Devitrification | not | not | occurred | occurred | occurred |
| Condition of heat | 700° C. 4 hr | 700° C. 4 hr | 700° C. 4 hr | 700° C. 4 hr | 720° C. 4 hr |
| treatment | | | | | |
| Mean particle diameter | 140 nm | 130 nm | 80 nm | 60 nm | 100 nm |
| Appearance after heat | white | white | yellow | yellow | white |
| treatment | | | | | |
| AgClₓBr₁₋ₓ | x = 1.0 | x = 1.0 | x = 0.46 | x = 0.50 | x = 0.75 |
| Heat treatment at 900° C. | transparent | transparent | turbid | turbid | turbid |
| Temperature during drawing | — | — | — | — | — |
| Tensile stress | — | — | — | — | — |
| Reduction condition | — | — | — | — | — |
| Extinction ratio at 1550 nm | — | — | — | — | — |
| Insertion loss at 1550 nm | — | — | — | — | — |
| Extinction ratio at 1310 nm | — | — | — | — | — |
| Insertion loss at 1310 nm | — | — | — | — | — |

### Comparative Examples 6 to 8

Comparative Examples 6 to 8 presented in Table 3-2 show the compositions of the polarizing glasses in examples described in the above mentioned Patent Documents 5, 4 and 8, respectively, and their treatment conditions and performances. These glasses also were produced according to the compositions described in the table, and the changes in their appearance during heat treatment, such as devitrification, were observed. The results with the symbol “*” in Comparative Examples 6 to 8 are the results of the glasses which were actually produced and melted by the present inventors for comparison. Devitrification was observed in the glasses of Comparative Examples 6 and 7. The glass of Comparative Example 8 is prone to becoming turbid in spite of its low concentration of Ag component, 0.24 wt %.

TABLE 3-2

| | Comparative | | Comparative | Comparative | |
|---|---|---|---|---|---|
| | Example 6 | | Example 7 | Example 8 | |
| | (Example 2 of | | (Example 2 of | (Example of | |
| | Patent | | Patent | Patent | |
| | Document 5) | | Document 4) | Document 8) | |
| SiO₂ | 57.5 | | 55.9 | 56.3 | |
| B₂O₃ | 20.5 | | 17.9 | 18.2 | |
| Al₂O₃ | 3.5 | | 6.1 | 6.2 | |
| ZrO₂ | 6.5 | | 4.9 | 5.0 | |
| TiO₂ | — | | 2.2 | 2.3 | |
| Li₂O | 1.8 | | 1.8 | 1.8 | |
| Na₂O | — | | 4.0 | 5.5 | |
| K₂O | 9.0 | | 5.7 | 5.7 | |
| MgO | — | | — | — | |
| CaO | — | | — | — | |
| SrO | — | | — | — | |
| BaO | 1.2 | | — | — | |
| ZnO | — | | — | — | |
| Ag | 0.40 | | 0.22 | 0.24 | |
| Cl | 0.50 | | 0.24 | 0.16 | |
| Br | 0.30 | | 0.20 | 0.16 | |
| F | — | | — | — | |
| CuO | — | | 0.006 | 0.010 | |
| CeO₂ | — | | 0.594 | — | |
| Ag × (Br − F) | 0.12 | | 0.04 | 0.04 | |
| Molar ratio Ag/(Cl + Br) | 0.21 | | 0.22 | 0.34 | |
| Molar ratio Cl/(Cl + Br + F) | 0.79 | | 0.73 | 0.69 | |
| Molar ratio Br/(Cl + Br + F) | 0.21 | | 0.27 | 0.31 | |
| Molar ratio F/(Cl + Br + F) | 0.00 | | 0.00 | 0.00 | |
| Devitrification | occurred * | | occurred * | not * | |
| Condition of heat treatment | 730° C. 2 hr | | 720° C. 2 hr | 710° | C. |
| Mean particle diameter | 95 | nm | — | — | |
| Appearance after heat | white | | yellow | blue * | |
| treatment | | | | | |
| AgClₓBr₁₋ₓ | — | | — | — | |
| Heat treatment at 900° C. | turbid * | | turbid * | turbit * | |
| Temperature during drawing | 675° | C. | — | 580~610° | C. |
| Tensile stress | 200 | kgf/cm² | — | — | |
| Reduction condition | 430° C. 8 hr | | — | 100 atm | |
| | | | | 350° C. 1 hr | |
| Extinction ratio at 1550 nm | 50 | dB | — | not more | |
| | | | | than 40 dB | |
| Insertion loss at 1550 nm | 0.03 | dB | — | — | |
| Extinction ratio at 1310 nm | 56 | dB | — | 50~60 | dB |

| | | | | |
|---|---|---|---|---|
| Insertion loss at 1310 nm | 0.03 | dB | — | — |

### Examples 18 to 21

Mother glasses having the compositions of Examples 18 to 21 shown in Table 4 were prepared. Namely, raw materials which had been mixed so as to give each composition were melted in a 500-cc platinum crucible at a temperature of 1450 to 1600° C., poured into a mold, and cooled to a temperature below the glass transition point to give mother glass blocks. The glasses thus obtained were treated and accessed according to the conditions indicated in the table, in the same manner as Examples 1 to 17.

TABLE 4

| | Example 18 | | Example 19 | | Example 20 | | Example 21 | |
|---|---|---|---|---|---|---|---|---|
| SiO₂ | 49.8 | | 49.8 | | 49.8 | | 49.8 | |
| B₂O₃ | 21.3 | | 21.3 | | 21.3 | | 21.3 | |
| Al₂O₃ | 6.9 | | 6.9 | | 6.9 | | 6.9 | |
| ZrO₂ | 8.5 | | 8.5 | | 8.5 | | 8.5 | |
| TiO₂ | — | | — | | — | | — | |
| Li₂O | 5.0 | | 5.0 | | 5.0 | | 5.0 | |
| Na₂O | 5.0 | | 5.0 | | 5.0 | | 5.0 | |
| K₂O | 4.2 | | 4.2 | | 4.2 | | 4.2 | |
| MgO | — | | — | | — | | — | |
| CaO | — | | — | | — | | — | |
| SrO | — | | — | | — | | — | |
| BaO | — | | — | | — | | — | |
| ZnO | — | | — | | — | | — | |
| Ag | 0.43 | | 0.43 | | 0.43 | | 0.43 | |
| Cl | 0.30 | | 0.30 | | 0.30 | | 0.22 | |
| Br | 0.13 | | 0.13 | | 0.13 | | 0.13 | |
| F | 0.00 | | 0.00 | | 0.00 | | 0.04 | |
| CuO | | | — | | — | | — | |
| CeO₂ | — | | — | | — | | — | |
| Ag × (Br − F) | 0.06 | | 0.06 | | 0.06 | | 0.04 | |
| Molar ratio Ag/(Cl + Br) | 0.36 | | 0.36 | | 0.36 | | 0.45 | |
| Molar ratio Cl/(Cl + Br + F) | 0.85 | | 0.85 | | 0.85 | | 0.65 | |
| Molar ratio Br/(Cl + Br + F) | 0.15 | | 0.15 | | 0.15 | | 0.15 | |
| Molar ratio F/(Cl + Br + F) | 0.00 | | 0.00 | | 0.00 | | 0.20 | |
| Devitrification | not | | not | | not | | not | |
| Condition of heat treatment | 680° C. 4 hr | | 680° C. 4 hr | | 680° C. 4 hr | | 680° C. 4 hr | |
| Mean particle diameter | 60 | nm | 60 | nm | 60 | nm | 50 | nm |
| Appearance after heat | white | | white | | white | | white | |
| treatment | | | | | | | | |
| AgClₓBr₁₋ₓ | x = 0.74 | | x = 0.74 | | x = 0.74 | | x = 0.74 | |
| Heat treatment at 900° C. | turbid | | turbid | | turbid | | turbid | |
| Temperature during drawing | 630° | C. | 630° | C. | 620° | C. | 620° | C. |
| Tensile stress | 270 | kgf/cm² | 170 | kgf/cm² | 300 | kgf/cm² | 310 | kgf/cm² |
| Cross sectional area ratio | 1/25 | | 1/24 | | 1/25 | | 1/25 | |
| after drawing*¹ | | | | | | | | |
| Reduction condition | 480° C. 2 hr | | 480° C. 2 hr | | 480° C. 2 hr | | 480° C. 2 hr | |
| Extinction ratio at 633 nm | 36.5 | dB | 3.4 | dB | 52 | dB | 16 | dB |
| Insertion loss at 633 nm | 0.5 | dB | 0.5 | dB | 0.5 | dB | 0.3 | dB |
| Extinction ratio at 532 nm | 25 | dB | 34.5 | dB | 26 | dB | 40 | dB |
| Insertion loss at 532 nm | 1.5 | dB | 2.4 | dB | 1.2 | dB | 1.2 | dB |

*¹Cross sectional area after drawing/Cross sectional area before drawing

As shown in Table 4, all glasses of Examples 18 to 21 exhibit excellent polarizing properties in the visible region. Spectral transmittance curves for the polarizing glasses of Examples 20 and 21 are shown in FIGS. 7 and 8, respectively. It is clear from the figures that these polarizing glasses have polarizing properties over a broad range in the visible region.

### INDUSTRIAL APPLICABILITY

The present invention makes it possible to easily produce a polarizing glass having a high extinction ratio, employing reduction with ambient-pressure hydrogen gas, instead of high pressures as in a conventional method. Therefore, the present method is much safer and superior in cost efficiency relative to the latter. The polarizing glass thus obtained can be used as a high extinction-ratio polarizing glass in such instruments that create or utilize polarized light, such as optical isolators, projectors and the like.

1. A method for production of a polarizing glass comprising geometrically anisotropic metallic silver particles dispersed and oriented at least in a surface layer thereof, which method comprises the steps of drawing a glass containing dispersed AgClₓBr₁₋ₓ(0≦x≦1) crystals, and then reducing the glass under a reduction atmosphere,
wherein the polarizing glass does not contain TiO₂ exceeding 1.7 wt %, but contains not less than 0.4 wt % Ag, and
wherein Ag and halogens contained in the polarizing glass satisfy the following relations:
the molar ratio of Ag/(Cl+Br) is 0.2 to 1.0,
the molar ratio of Cl/(Cl+Br+F) is 0.5 to 0.95, and
the molar ratio of Br/(Cl+Br+F) is 0.05 to 0.4.

2. The method for production of claim 1, wherein the halogens contained in the polarizing glass satisfy a relation that the molar ratio of F/(Cl+Br+F) is 0.01 to 0.4.

3. The method for production of claim 1, wherein the composition of the polarizing glass comprises
SiO₂: 40 to 63 wt %
B₂O₃: 15 to 26 wt %
Al₂O₃: 5 to 15 wt %
ZrO₂: 7 to 12 wt %
R¹₂O: 4 to 16 wt %
(wherein, R¹ inclusively represents Li, Na K and Cs, provided that these satisfy the following: Li₂O: 0 to 5 wt %, Na₂O: 0 to 9 wt %, K₂O: 0 to 12 wt %, Cs₂O: 0 to 6 wt %)
R²O: 0 to 7 wt %
(wherein, R² inclusively represents Mg, Ca, Sr and Ba, provided that these satisfy the following: MgO: 0 to 3 wt %, CaO: 0 to 3 wt %, SrO: 0 to 5 wt %, BaO: 0 to 5 wt %)
ZnO: 0 to 6 wt %
Ag: 0.4 to 1.5 wt %
Cl: 0.1 to 1.0 wt %
Br: 0.01 to 0.5 wt %, and
F: 0 to 0.2 wt %.

4. The method for production of claim 1, wherein x is not less than 0.5 in the AgClₓBr₁₋ₓ crystals.

5. The method for production of claim 1, wherein Ag, Br and F contained in the polarizing glass satisfy the following relation: Ag×(Br—F)≦0.1 in wt %.

6. The method for production of claim 5, wherein the extinction ratio of the polarizing glass is not less than 10 dB.

7. A polarizing glass produced by the method for production of claim 1.

8. A polarizing glass comprising geometrically anisotropic metallic silver particles dispersed and oriented at least in a surface layer thereof,
wherein the polarizing glass does not contain TiO₂ exceeding 1.7 wt %, but contains not less than 0.4 wt % Ag, and
wherein, at 633 nm, the loss is not more than 0.6 dB, and the extinction ratio is not less than 35 dB, and
wherein Ag and halogens contained in the polarizing glass satisfy the following relations:
the molar ratio of Ag/(Cl+Br) is 0.2 to 1.0,
the molar ratio of Cl/(Cl+Br+F) is 0.5 to 0.95, and
the molar ratio of Br/(Cl+Br+F) is 0.05 to 0.4.

9. A polarizing glass comprising geometrically anisotropic metallic silver particles dispersed and oriented at least in a surface layer thereof,
wherein the polarizing glass does not contain TiO₂ exceeding 1.7 wt %, but contains not less than 0.4 wt % Ag, and
wherein, at 532 nm, the loss is not more than 2.5 dB, and the extinction ratio is not less than 30 dB, and
wherein Ag and halogens contained in the polarizing glass satisfy the following relations:
the molar ratio of Ag/(Cl+Br) is 0.2 to 1.0,
the molar ratio of Cl/(Cl+Br+F) is 0.5 to 0.95, and
the molar ratio of Br/(Cl+Br+F) is 0.05 to 0.4.

10. The polarizing glass of claim 8, wherein halogens contained in the polarizing glass satisfy the following relation: the molar ratio of F/(Cl+Br+F) is 0 to 0.4.

11. The polarizing glass of claim 8, wherein the composition of the polarizing glass comprises
SiO₂: 40 to 63 wt %
B₂O₃: 15 to 26 wt %
Al₂O₃: 5 to 15 wt %
ZrO₂: 7 to 12 wt %
R¹₂O: 4 to 16 wt %
(wherein, R¹ inclusively represents Li, NaK and Cs, provided that these satisfy the following: Li₂O: 0 to 5 wt %, Na₂O: 0 to 9 wt %, K₂O: 0 to 12 wt %, Cs₂O: 0 to 6 wt %)
R²O: 0 to 7 wt %
(wherein, R² inclusively represents Mg, Ca, Sr and Ba, provided that these satisfy the following: MgO: 0 to 3 wt %, CaO: 0 to 3 wt %, SrO: 0 to 5 wt %, BaO: 0 to 5 wt %)
ZnO: 0 to 6 wt %
Ag: 0.4 to 1.5 wt %
Cl: 0.1 to 1.0 wt %
Br: 0.01 to 0.5 wt %, and
F: 0 to 0.2 wt %.

12. The polarizing glass of claim 8, wherein Ag and halogens contained in the polarizing glass satisfy the following relation:
Ag×(Br—F)≦0.1 in wt %.

13. The polarizing glass of claim 8, wherein the extinction ratio of the polarizing glass is not less than 10 dB.

14. The polarizing glass of claim 9, wherein halogens contained in the polarizing glass satisfy the following relation: the molar ratio of F/(Cl+Br+F) is 0 to 0.4.

15. The polarizing glass of claim 9, wherein the composition of the polarizing glass comprises
SiO₂: 40 to 63 wt %
B₂O₃: 15 to 26 wt %
Al₂O₃: 5 to 15 wt %
ZrO₂: 7 to 12 wt %
R¹₂O: 4 to 16 wt %
(wherein, R¹ inclusively represents Li, NaK and Cs, provided that these satisfy the following: Li₂O: 0 to 5 wt %, Na₂O: 0 to 9 wt %, K₂O: 0 to 12 wt %, Cs₂O: 0 to 6 wt %)
R²O: 0 to 7 wt %
(wherein, R² inclusively represents Mg, Ca, Sr and Ba, provided that these satisfy the following: MgO: 0 to 3 wt %, CaO: 0 to 3 wt %, SrO: 0 to 5 wt %, BaO: 0 to 5 wt %)
ZnO: 0 to 6 wt %
Ag: 0.4 to 1.5 wt %
Cl: 0.1 to 1.0 wt %
Br: 0.01 to 0.5 wt %, and
F: 0 to 0.2 wt %.

16. The polarizing glass of claim 9, wherein Ag and halogens contained in the polarizing glass satisfy the following relation: Ag×(Br—F)≦0.1 in wt %.

17. The polarizing glass of claim 9, wherein the extinction ratio of the polarizing glass is not less than 10 dB.
